(19) United States
(12) Patent Application Publication
(10) Pub. No.: US 2016/0125749 A1
(43) Pub. Date: May 5, 2016

(54) USER INTERFACE FOR A/B TESTING

(71) Applicant: LinkedIn Corporation, Mountain View, CA (US)

(72) Inventors: Erin Louise Delacroix, Vallejo, CA (US); Omar Sinno, San Francisco, CA (US); Ya Xu, Los Altos, CA (US)

(21) Appl. No.: 14/582,012

(22) Filed: Dec. 23, 2014

Related U.S. Application Data
(60) Provisional application No. 62/072,963, filed on Oct. 30, 2014.

(51) Int. Cl. G09B 7/00

(52) U.S. Cl. CPC G09B 7/00

(57) ABSTRACT

Techniques for conducting A/B testing are described. According to various embodiments, a user request to configure an A/B test is received, and a targeting user interface is displayed. The targeting user interface includes a group of one or more windows, each of the windows being configured to display one or more user-specified targeting criteria statements that identify members of an online social networking service based on member attributes of the members. Thereafter, a user specification of one or more targeting criteria statements is received in conjunction with one or more of the windows. Targeting criteria information defining a set of members of the online social networking service to be targeted for the A/B test is then generated, the targeting criteria information indicating that all members satisfying all the targeting criteria statements for any window in the group of windows are to be targeted for the A/B test.

### CROSS-REFERENCE TO RELATED APPLICATIONS

The present application claims the priority benefit of U.S. Provisional Application No. 62/072,963, filed Oct. 30, 2014, entitled “A/B TESTING SYSTEM”, which is incorporated by reference herein in its entirety.

### TECHNICAL FIELD

The present application relates generally to data processing systems and, in one specific example, to techniques for conducting A/B testing of online content.

### BACKGROUND

The practice of A/B testing, also known as “split testing,” is a practice for making improvements to webpages and other online content. A/B testing typically involves preparing two versions (also known as variants, or treatments) of a piece of online content, such as a webpage, a landing page, an online advertisement, etc., and providing them to separate audiences to determine which variant performs better.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a flowchart illustrating an example method, according to various embodiments;

FIG. 4 illustrates an example portion of a user interface, according to various embodiments;

FIG. 5 is a flowchart illustrating an example method, according to various embodiments;

FIG. 6 illustrates example portions of user interfaces, according to various embodiments;

FIG. 7 is a flowchart illustrating an example method, according to various embodiments;

FIG. 8 illustrates example portions of user interfaces, according to various embodiments;

FIG. 9 illustrates example portions of user interfaces, according to various embodiments;

FIG. 10 is a flowchart illustrating an example method, according to various embodiments;

FIG. 11 is a flowchart illustrating an example method, according to various embodiments;

FIG. 12 is a flowchart illustrating an example method, according to various embodiments;

FIG. 13 illustrates an example mobile device, according to various embodiments; and

FIG. 14 is a diagrammatic representation of a machine in the example form of a computer system within which a set of instructions, for causing the machine to perform any one or more of the methodologies discussed herein, may be executed.

### DETAILED DESCRIPTION

Example methods and systems for conducting A/B testing of online content are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various example embodiments, an A/B testing system is configured to enable a user to prepare and conduct an A/B test of online content among members of an online social networking service such as LinkedIn®. The A/B testing system may display a targeting user interface allowing the user to specify targeting criteria statements that reference members of an online social networking service based on their member attributes (e.g., their member profile attributes displayed on their member profile page, or other member attributes that may be maintained by an online social networking service that may not be displayed on member profile pages). For example, the user can enter statements such as “role is sales”, “industry is technology” “connection count>500”, “account is premium”, and so on.

In some embodiments, the A/B testing interface allows the user to define different alternative sets of members that may be targeted by an A/B test. For example, the system may display a user interface with multiple windows (e.g., boxes) for specifying targeting criteria. Each of the boxes represents an alternative set of users, and members must satisfy all the criteria within a given box in order to be targeted. Put another, the statements within each box are related via an “AND” Boolean logic operator, whereas criteria associated with different boxes are related via an “OR” Boolean logic operator, for the purposes of generating final targeting criteria. For example, suppose a first box contains statements x, y, and z, a second box contains statements u and v, and a third box contains statement w. Thus, the system will target all users that satisfy criteria x AND y AND z, and all users that satisfy criteria u and v, and all users that satisfy criteria w.

Once the total set of users to be targeted has been defined, the system allows the user to define different variants for the experiment, such as by uploading files, images, HTML code, webpages, data, etc., associated with each variant and providing a name for each variant. One of the variants may correspond to a control variant (e.g., an existing variant). For example, if the A/B test is testing a user response (e.g., click through rate or CTR) for a button on a homepage of an online social networking service, the different variants may correspond to different types of buttons such as a blue circle button, a blue square button with rounded corners, and so on. Thus, the user may upload an image file of the appropriate buttons and/or code (e.g., HTML code) associated with different versions of the webpage containing the different variants.

Thereafter, the system may display an allocation bar allowing the user to target different variants to different percentages of the targeted set of users. For example, the user may target 10% of the set of members with variant A, 20% of the set of members with variant B, and the remaining 70% of members with a control variant, via an intuitive and easy to use user interface. The user may also change the allocation criteria by, for example, modifying the aforementioned percentages and variants. Moreover, the user may instruct the system to execute the A/B test, and the system will identify and target the appropriate percentages of the targeted set of members with the appropriate variants.

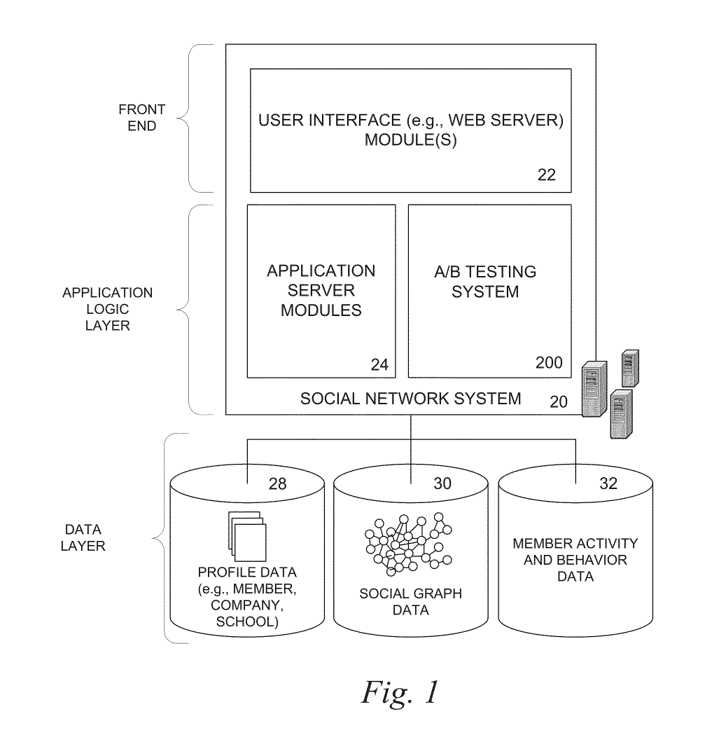

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data tier various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

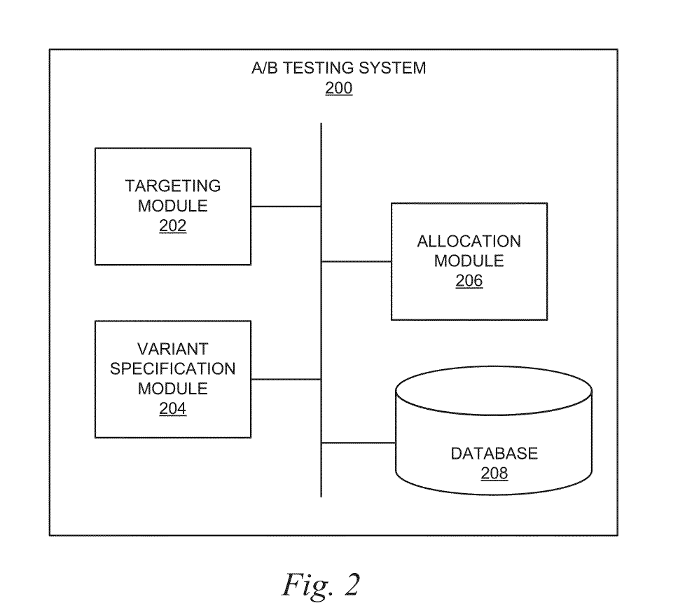

With some embodiments, the social network system 20 includes what is generally referred to herein as an A/B testing system 200. The A/B testing system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, an A/B testing system 200 includes a targeting module 202, a variant specification module 204, an allocation module 206, and a database 208. The modules of the A/B testing system 200 may be implemented on or executed by a single device such as an A/B testing device, or on separate devices interconnected via a network. The aforementioned A/B testing device may be, for example, one or more client machines or application servers. The operation of each of the aforementioned modules of the A/B testing system 200 will now be described in greater detail in conjunction with the various figures.

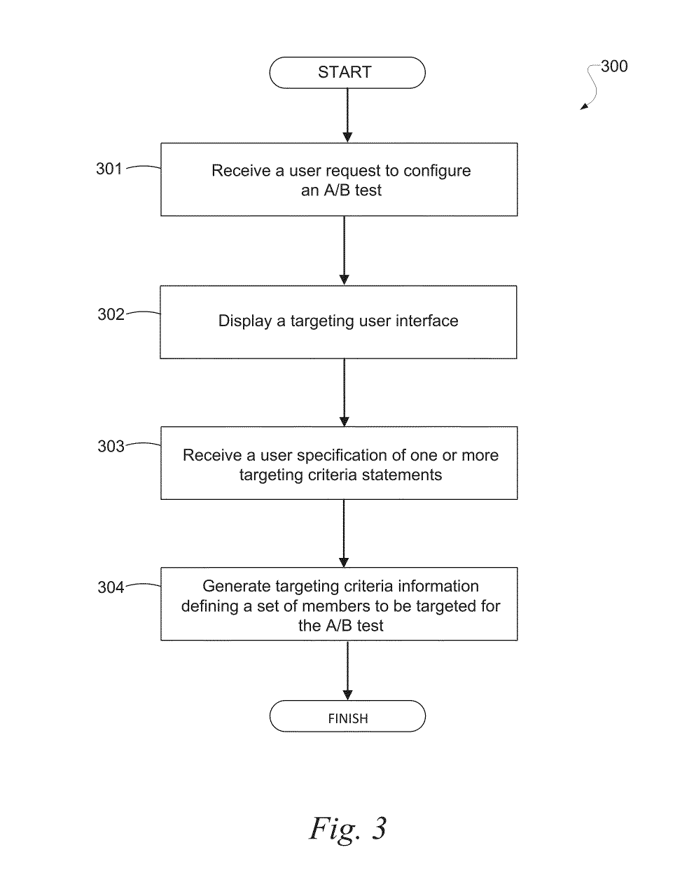

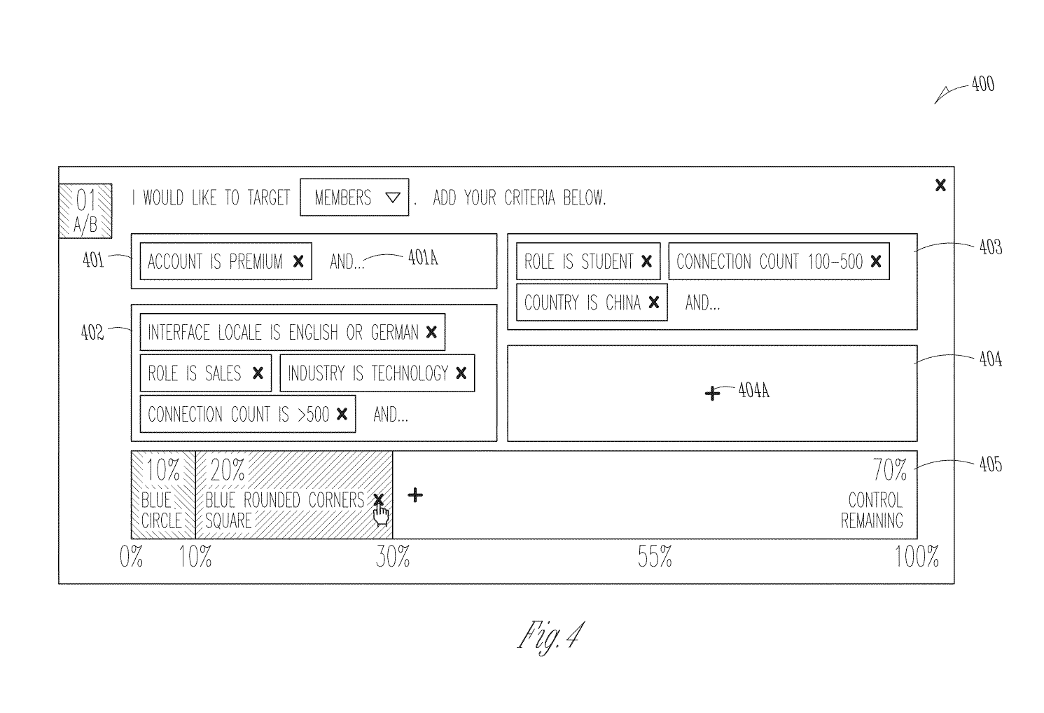

FIG. 3 is a flowchart illustrating an example method 300, consistent with various embodiments described above. The method 300 may be performed at least in part by, for example, the A/B testing system 200 illustrated in FIG. 2 (or an apparatus having similar modules, such as one or more client machines or application servers). In operation 301, the targeting module 202 receives, via a user interface, a user request to configure an A/B test of online content. For example, a user may select a “configure A/B test” button in a user interface (not shown). In operation 302, the targeting module 202 displays a targeting user interface, the targeting user interface including a group of one or more windows. Each of the windows may be configured to display one or more user-specified targeting criteria statements that identify members of an online social networking service based on member profile attributes of the members. For example, FIG. 4 illustrates an exemplary targeting user interface 400 that includes three windows 401-403, where each of the windows is configured to display user-specified targeting criteria statements (e.g., “account is premium”).

In operation 303 in FIG. 3, the targeting module 202 receives a user specification of one or more targeting criteria statements in conjunction with one or more of the windows. For example, as illustrated in FIG. 4, the user has specified the statement “account is premium” in window 401, as well as other statements in windows 402 and 403. The user may add statements to a given window 401-403 by, for example, clicking on the “and . . . ” option (e.g., 401a) in each of the windows 401-403, in which case a cursor may be displayed and the user may type in text such as “country is China”, “industry is technology”, etc. Moreover, the user may enter statements into anew box, such as box 404, by selecting the plus button 404a in box 404, which will enable the user to enter statements into the box 404. In some embodiments, each of the targeting criteria statements includes a member profile attribute, an operator, and a value (e.g., “country is China”). In some embodiments, the member profile attribute is any of age, location, role, industry, language, current job, employer, experience, skills, education, school, endorsements, seniority level, company size, connections, connection count, account level, name, username, social media handle, email address, phone number, fax number, resume information, title, activities, group membership, images, photos, preferences, news, status, links or URLs on a profile page, and so forth. In some embodiments, the operator is at least one of an “is” operator, an “is not” operator, an “and” operator, an “or” operator, a “nor” operator, an “equals” operator, a “greater than” operator, a “less than” operator, a “greater than or equal to” operator, or “a less than or equal to” operator.

In operation 304 in FIG. 3, the targeting module 202 generates targeting criteria information defining a set of members of the online social networking service to be targeted for the A/B test. More specifically, the targeting criteria information wilt indicate that all members satisfying all the targeting criteria statements for any given window in the group of windows are to be targeted for the A/B test. For example, with reference to FIG. 4, the targeting module 202 will generate targeting criteria indicating that, for example, (a) all the members who have premium accounts are to be targeted, and (b) members whose interface local is German or English AND whose role is sales AND whose industry is technology AND whose connection count is greater than 500 are to be targeted, and (c) members whose role is student AND whose connection count is 100-500 AND whose country is China are to be targeted. The aforementioned targeting criteria information may be stored at, for example, database 208 in FIG. 2. It is contemplated that the operations of method 300 may incorporate any of the other features disclosed herein. Various operations in the method 300 may be omitted or rearranged, as necessary.

In some embodiments, the variant specification module 204 may display a variant specification user interface window configured to receive a user specification of variant definition information defining one or more variants of the A/B test, the variant definition information for each of the variants including a name of the variant and a reference link to a data file including the variant. In some embodiments, at least one of the variants corresponds to a control variant, and may be named as such.

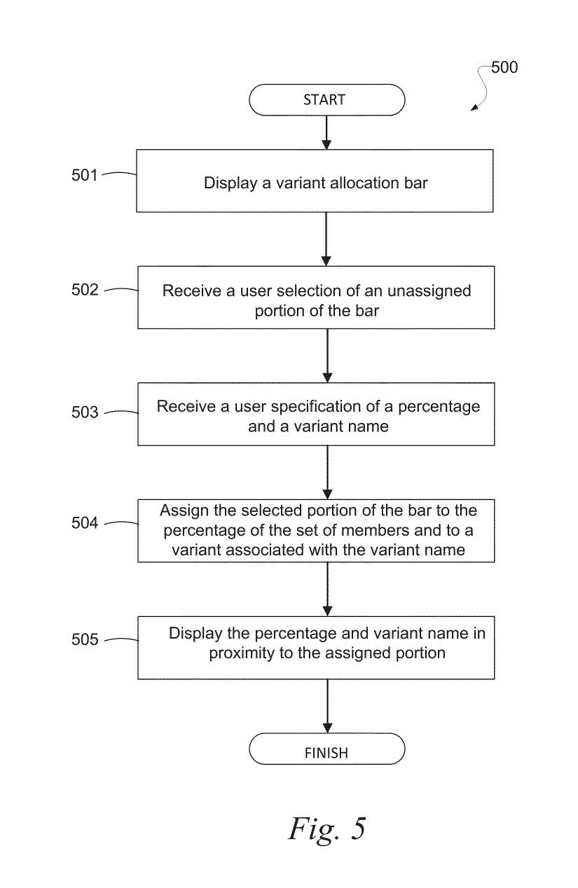

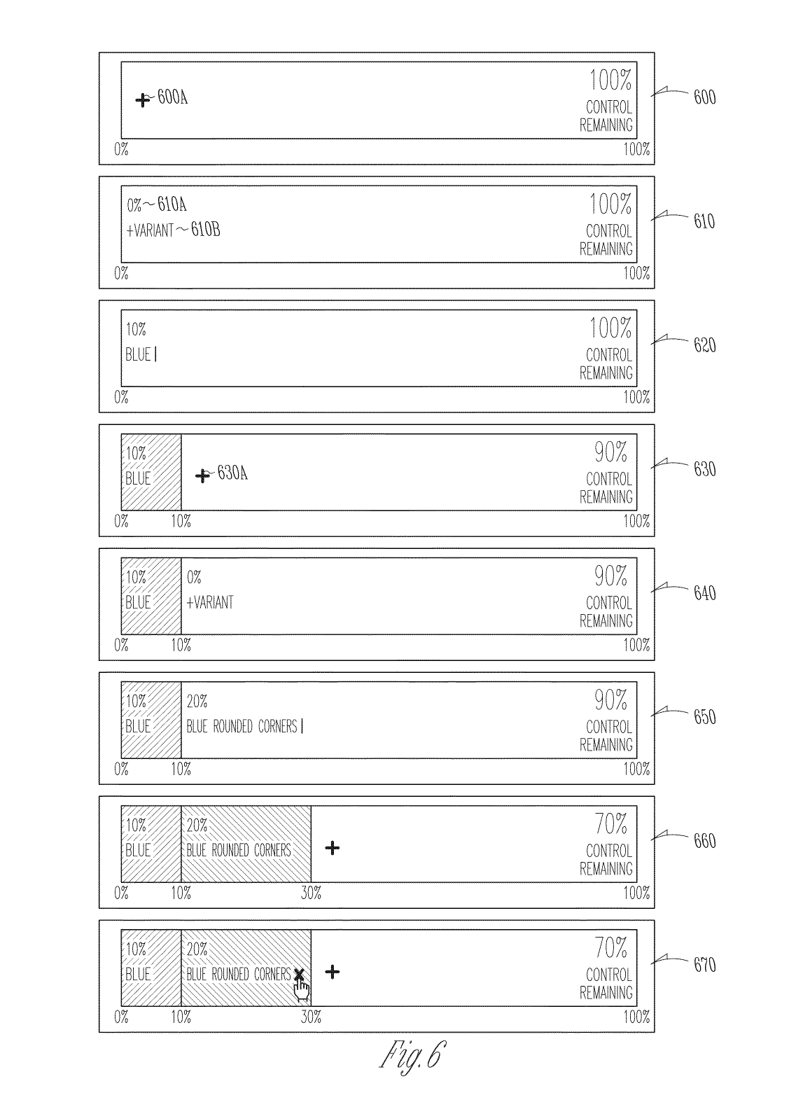

FIG. 5 is a flowchart illustrating an example method 500, consistent with various embodiments described above. The method 500 may be performed after the method 300 described above. The method 500 may be performed at least in part by, for example, the A/B testing system 200 illustrated in FIG. 2 (or an apparatus having similar modules, such as one or more client machines or application servers). In operation 501, the allocation module 206 displays a variant allocation bar representing the set of members targeted for the A/B test. An example of a fully configured variant allocation bar 405 is illustrated in FIG. 4. Moreover, FIG. 6 illustrates another example of various states 600-670 of a variant allocation bar as it is being configured, as described in more detail below. As illustrated in state 600, the allocation bar is entirely unassigned/unallocated.

In operation 502 in FIG. 5, the allocation module 206 receives a user selection of an unassigned portion of the allocation bar. For example, suppose that in state 600 in FIG. 6, the user has clicked on the “+” button 600a. In state 610 the system then displays 2 text entry elements 610a and 610b for specifying a percentage (currently set at 0%) and for adding a variant name. In operation 503 in FIG. 5, the allocation module 206 receives a user specification of a percentage and a variant name. For example, as seen in state 620 in FIG. 6, the user has specified the percentage 10%, and specified the variant name “Blue”. In operation 504 in FIG. 5, the allocation module 206 assigns the selected portion of the bar to the aforementioned percentage of the set of members and to a variant associated with the aforementioned variant name (specified in operation 503). For example, as seen in state 630 in FIG. 6, the targeting module 202 has assigned the selected portion of the bar to 10% of the targeted members and to the blue variant. In operation 505, the allocation module 206 displays the percentage and variant name in proximity to the assigned portion (e.g., see state 630 in FIG. 6). The allocation module 206 may also display indicia on the bar indicating the assigned portion and highlighting a percentage of the bar corresponding to the user-specified percentage (e.g., see state 630 in FIG. 6, where the highlighted portion corresponds to approximately 10% of the allocation bar). As seen in states 630, 640, and 650 in FIG. 6, the user can repeat the process by clicking on an unassigned portion (e.g., represented by the “+” 630a button in state 630), being provided with an interface to enter a percentage and a variant name (see state 640), entering the percentage and variant name for the selected portion (see state 650), and the allocation module 206 will ultimately display indicia representing the added portion (see state 660). It is contemplated that the operations of method 500 may incorporate any of the other features disclosed. herein. Various operations in the method 500 may be omitted or rearranged, as necessary.

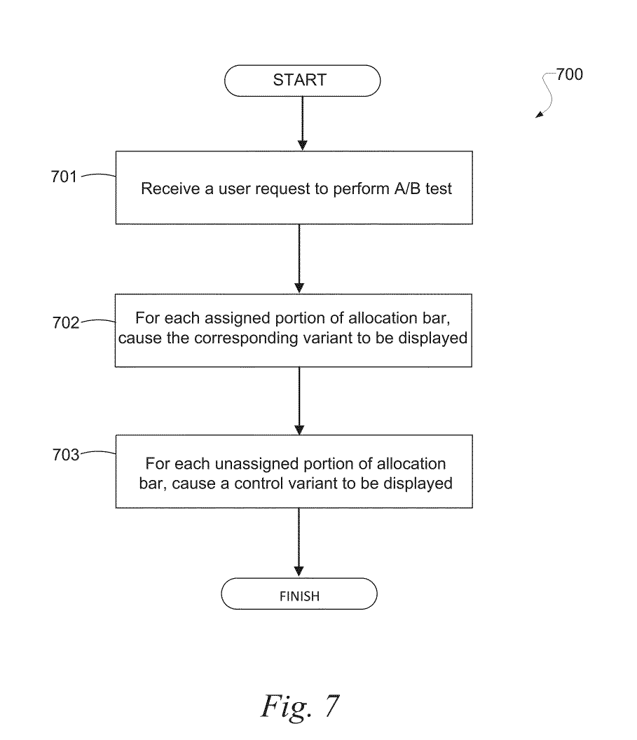

FIG. 7 is a flowchart illustrating an example method 700, consistent with various embodiments described above. The method 700 may be performed after, for example, the method 500 in FIG. 5. The method 700 may be performed at least in part by, for example, the A/B testing system 200 illustrated in FIG. 2 (or an apparatus having similar modules, such as one or more client machines or application servers). In operation 701, the allocation module 206 receives a user request to perform the A/B test; for example, the user may select a “run A/B test now” button (not shown) in the user interface in FIG. 4. In operation 702, for each assigned portion of the bar, the allocation module 206 causes the variant associated with the corresponding variant name to be displayed to the corresponding percentage of the set of members. For example, with reference to the allocation bar 405 in FIG. 4, the allocation module 206 will cause the “blue circle” variant to be displayed to 10% of the targeted set of members and the “blue rounded corners square” variant to be displayed to 20% of the targeted set of members, (where the targeted set of members is defined by the targeting criteria in boxes 401-403, as described above). In operation 703 in FIG. 7, for each unassigned portion of the allocation bar, the allocation module 206 causes a control variant to be displayed to the corresponding percentage of the set of members. For example, with reference to the allocation bar 405 in FIG. 4, the allocation module 206 will cause the remaining 70% of unassigned members to receive the control variant by default. It is contemplated that the operations of method 700 may incorporate any of the other features disclosed herein. Various operations in the method 700 may be omitted or rearranged, as necessary.

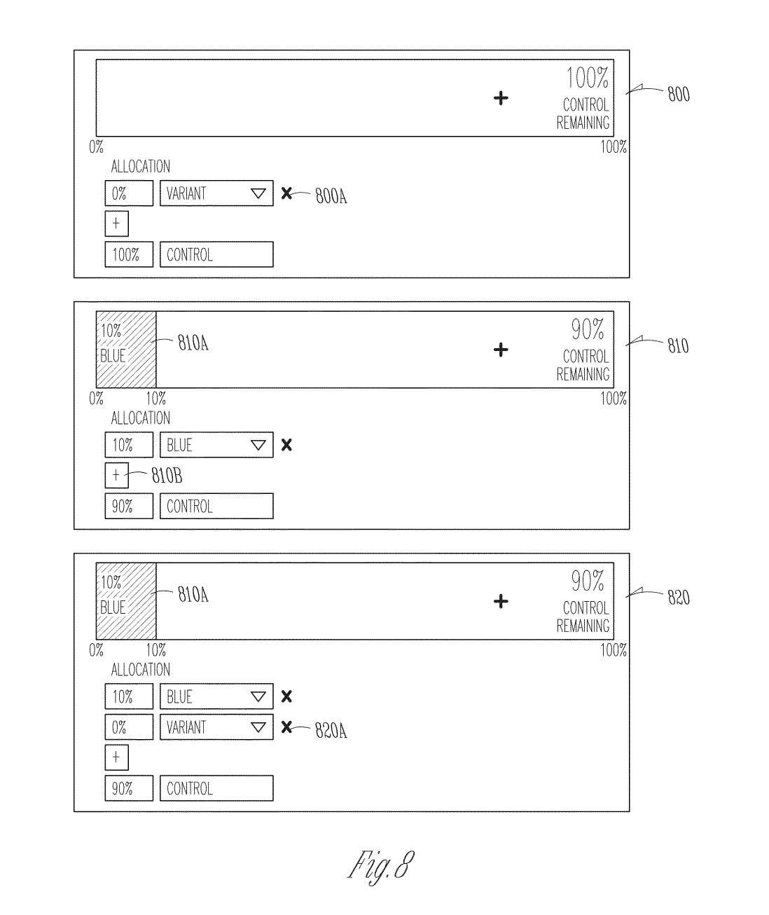

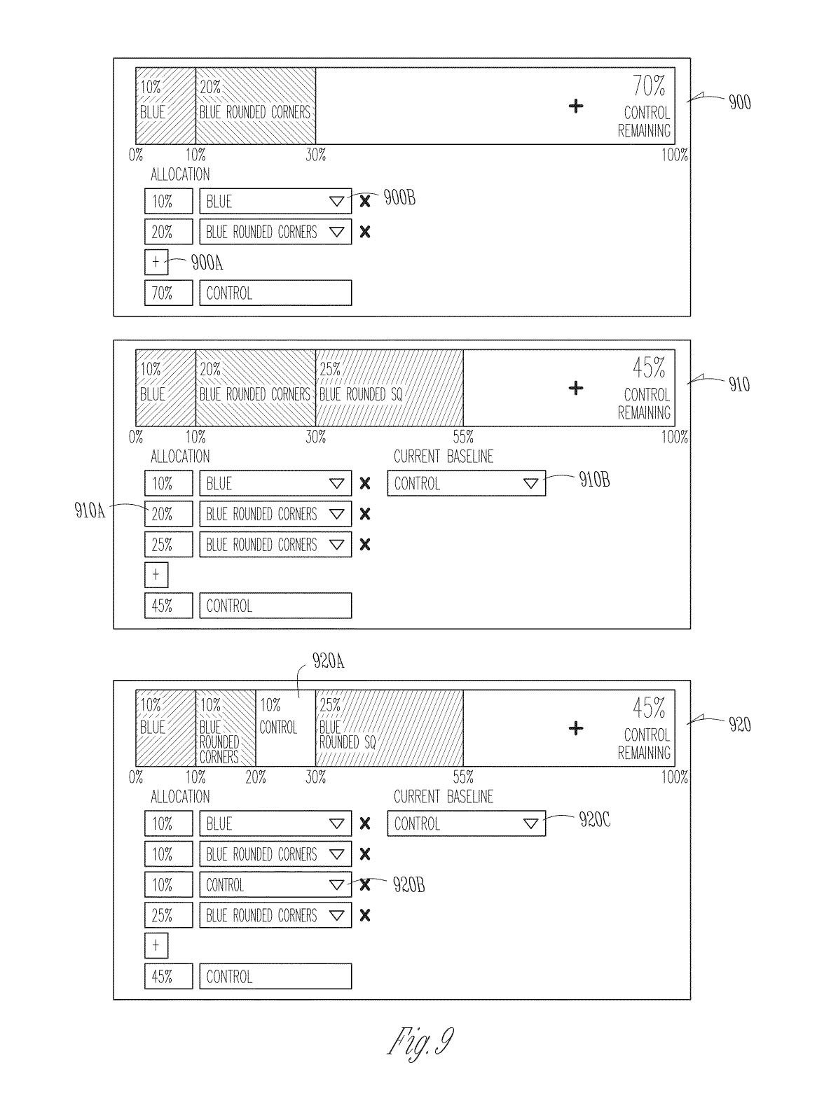

While the examples in FIG. 6 described above shown an exemplary process for configuring an allocation bar, an alternative process is depicted in FIGS. 8 and 9. For example, state 800 shows an allocation bar that is entirely unassigned. The user may select the first allocation entry line 800a in order to specify the percentage and variant name for a first portion (e.g., 10% for the “blue” variant) to be allocated/assigned, as seen in state 810. Moreover, as illustrated in state 810, the system will display the corresponding indicia 810a for the newly assigned portion of the allocation bar, consistent with the embodiments described above. If the user clicks on the “+” button 810b, the user may be presented with an additional allocation entry line 820a, as illustrated in state 820. The user may enter the additional information for the additional portion (e.g., 20% for variant “blue rounded comers”), as illustrated in state 900. Similarly, the user may continue this process by clicking on the “+” button 900a in state 900 in FIG. 9, in order to assign/allocate an additional portion of the allocation bar (e.g., 25% for “blue rounded square” variant),as illustrated in state 910.

Moreover, in some embodiments, the user can modify a percentage for an already assigned portion of the allocation bar. For example, if the user selects the “20%” percentage in the user entry line 910a for the “blue rounded corners” variant illustrated in state 910, then the user may change this percentage to 10%, as seen in state 920. In response, the system 200 will automatically assign the remaining (and now unassigned) 10% of targeted members to the control variant, as illustrated by indicia 920a in state 920. Moreover, the system 200 will display an allocation entry line 920b for this newly created control portion of the allocation bar. The user can adjust the “current baseline” element 910b in state 910 in order to change the current baseline or default allocation, in cases where a percentage allocation change results in a newly unassigned percentage of members. For example, if the user had changed the baseline from “Control” to “Blue” in state 910, then the unassigned portion corresponding to indicia 920a in state 920 would have been assigned to the “Blue” variant rather than the “Control” variant.

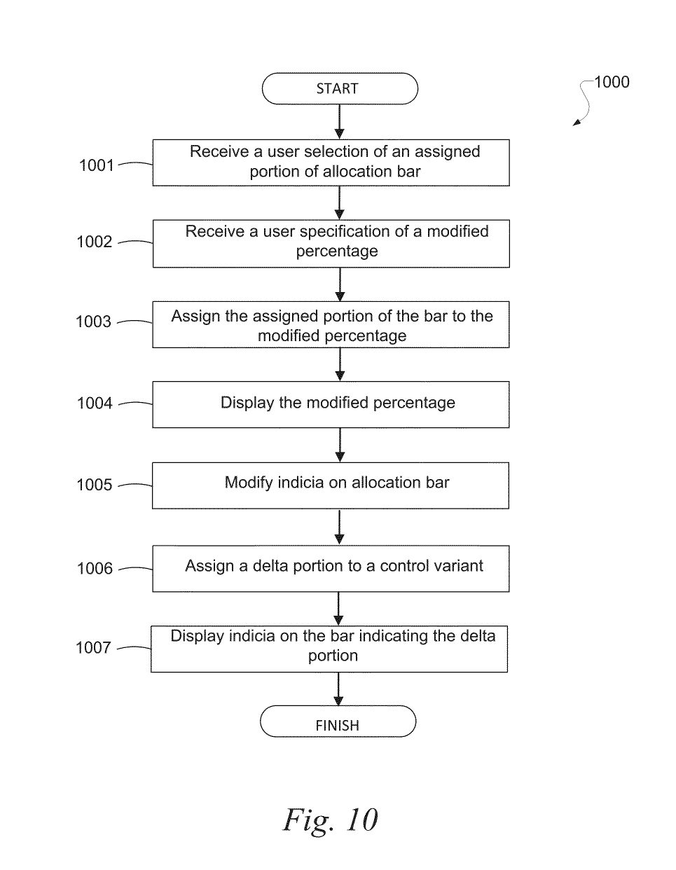

FIG. 10 is a flowchart illustrating an example method 1000, consistent with various embodiments described above. The method 1000 may be performed after the method 500 in FIG. 5. The method 1000 may be performed at least in part by, for example, the A/B testing system 200 illustrated in FIG. 2 (or an apparatus having similar modules, such as one or more client machines or application servers). In operation 1001, the allocation module 206 receives a user selection of an assigned portion of the bar assigned to a percentage of a set of targeted members (e.g., a user selection of the “20%” entry element 910a in state 910 in FIG. 9). In operation 1002 in FIG. 10, the allocation module 206 receives a user specification of a modified percentage (e.g., see state 920 in FIG. 9, where the user has changed 20% for the “blue rounded corners” variant to 10%). In operation 1003 in FIG. 10, the allocation module 206 assigns the assigned portion of the bar to the modified percentage of the set of members e.g., see state 920 in FIG. 9). In operation 1004, the allocation module 206 displays the modified percentage in proximity to the assigned portion (e.g., see state 920 in FIG. 9). In operation 1005, the allocation module 206 modifies indicia on the bar indicating the assigned portion to highlight a percentage of the bar corresponding to the modified percentage (e.g., see state 920 in FIG. 9, where the “blue rounded corners” indicia has been halved in size). In operation 1006, responsive to determining that the modified percentage is less than the original percentage by a delta percentage, the allocation module 206 assigns a delta portion of the bar corresponding to the delta percentage to a control variant (e.g., see delta portion 920a in state 920 in FIG. 9). In operation 1007, the allocation module 206 displays indicia on the bar indicating the delta portion and highlighting a percentage of the bar corresponding to the delta percentage (e.g., see delta portion 920a in state 920 in FIG. 9). It is contemplated that the operations of method 1000 may incorporate any of the other features disclosed herein. Various operations in the method 1000 may be omitted or rearranged, as necessary. For example, operators 1006 and 1007 may be omitted.

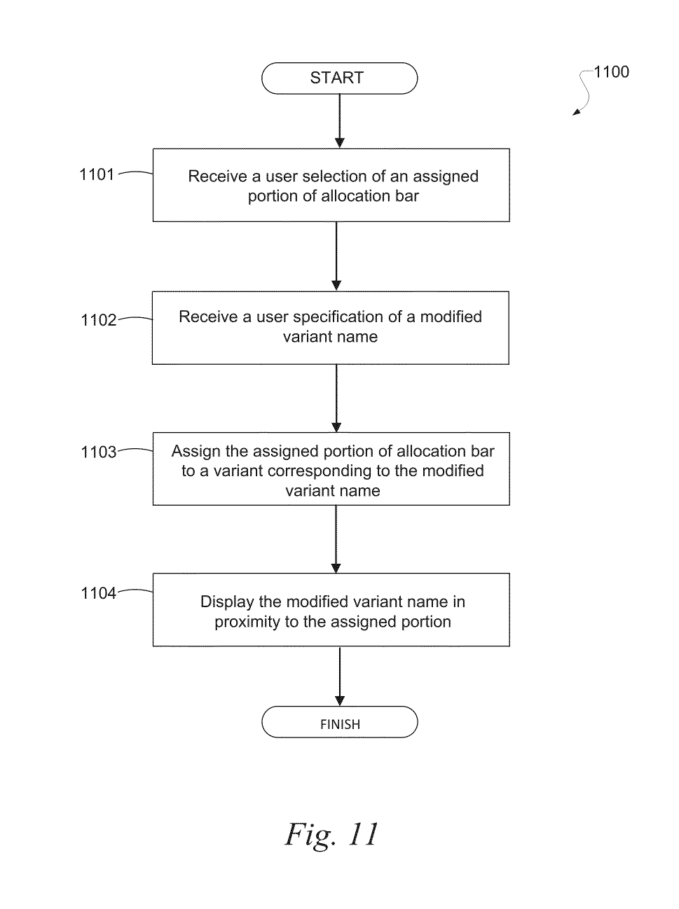

FIG. 11 is a flowchart illustrating an example method 1100, consistent with various embodiments described above. The method 1000 may be performed after the method 500 in FIG. 5. The method 1100 may be performed at least in part by, for example, the A/B testing system 200 illustrated in FIG. 2 (or an apparatus having similar modules, such as one or more client machines or application servers). In operation 1101, the allocation module 206 receives a user selection of an assigned portion of an allocation bar. For example, the user may click on the pull down menu 900b identifying the “Blue” variant in state 900 in FIG. 9. In operation 1102, the allocation module 206 receives a user specification of a modified variant name. For example, the user may manipulate the pull-down menu 900b in state 900 in FIG. 9 in order to select another variant, such as “Red”. In operation 1103, the allocation module 206 assigns the assigned portion of the allocation bar to a variant corresponding to the modified variant name. In operation 1104, the allocation module 206 displays the modified variant name in proximity to the assigned portion. It is contemplated that the operations of method 1100 may incorporate any of the other features disclosed herein. Various operations in the method 1100 may be omitted or rearranged, as necessary.

In some embodiments, the pull-down menu 900b in state 900 in FIG. 9 for selecting variants is pre-populated with all the variants that the user has specified (e.g., in conjunction with the variant specification user interface described above).

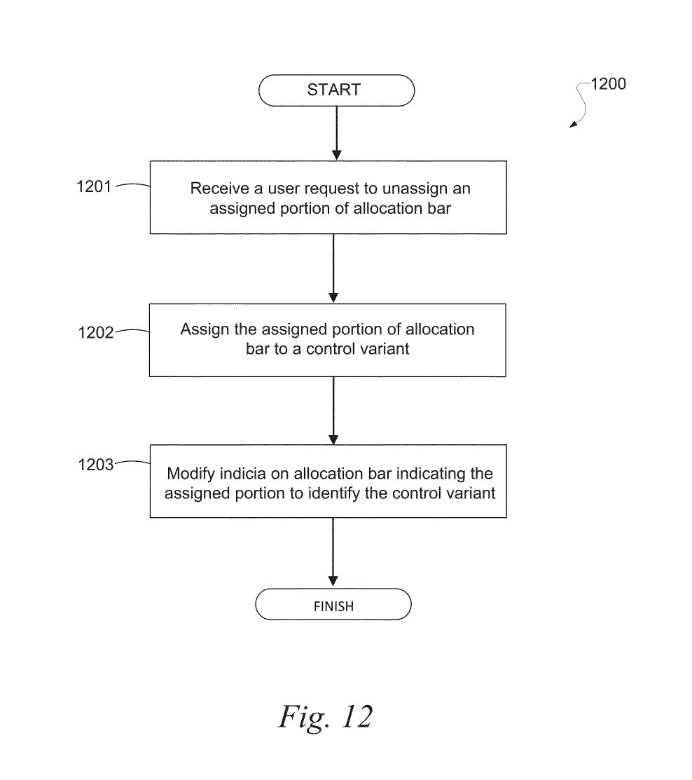

FIG. 12 is a flowchart illustrating an example method 1200, consistent with various embodiments described above. The method 1000 may be performed after the method 500 in FIG. 5. The method 1200 may be performed at least in part by, for example, the A/B testing system 200 illustrated in FIG. 2 (or an apparatus having similar modules, such as one or more client machines or application servers). In operation 1201, the allocation module 206 receives a user request to unassign an assigned portion of an allocation bar (see the cursor clicking on the “x” button in state 670 in FIG. 6). In operation 1202, the allocation module 206 assigns the assigned portion of the bar to a control variant. For example, with reference to state 670 in FIG. 6, the system will assign the 20% of the targeted set of members currently assigned to the “Blue Rounded Corners” variant to the control variant, so that a total of 90% of members will be assigned to the control variant. In operation 1203 in FIG. 12, the allocation module 206 modifies indicia on the bar indicating the assigned portion to identify the control variant. For example, with reference to state 670 in FIG. 6, the system will remove the highlighting associated with the “Blue Rounded Corners” variant, so that state 630 will be restored. It is contemplated that the operations of method 1200 may incorporate any of the other features disclosed herein. Various operations in the method 1200 may be omitted or rearranged, as necessary.

### Example Mobile Device

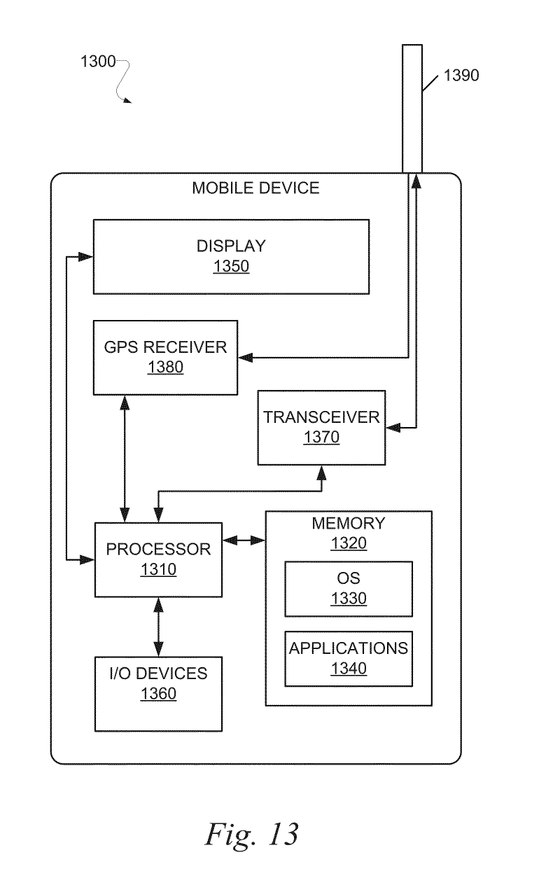

FIG. 13 is a block diagram illustrating the mobile device 1300, according to an example embodiment. The mobile device may correspond to, for example, one or more client machines or application servers. One or more of the modules of the system 200 illustrated in FIG. 2 may be implemented on or executed by the mobile device 1300. The mobile device 1300 may include a processor 1310. The processor 1310 may be any of a variety of different types of commercially available processors suitable for mobile devices (for example, an XScale architecture microprocessor, a Microprocessor without Interlocked Pipeline Stages (MIPS) architecture processor, or another type of processor). A memory 1320, such as a Random Access Memory (RAM), a Flash memory, or other type of memory, is typically accessible to the processor 1310. The memory 1320 may be adapted to store an operating system (OS) 1330, as well as application programs 1340, such as a mobile location enabled application that may provide location based services to a user. The processor 1310 may be coupled, either directly or via appropriate inter hardware, to a display 1350 and to one or more input/output (I/O) devices 1360, such as a keypad, a touch panel sensor, a microphone, and the like. Similarly, in some embodiments, the processor 1310 may be coupled to a transceiver 1370 that interfaces with an antenna 1390. The transceiver 1370 may be configured to both transmit and receive cellular network signals, wireless data signals, or other types of signals via the antenna 1390, depending on the nature of the mobile device 1300. Further, in some configurations, a GPS receiver 1380 may also make use of the antenna 1390 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

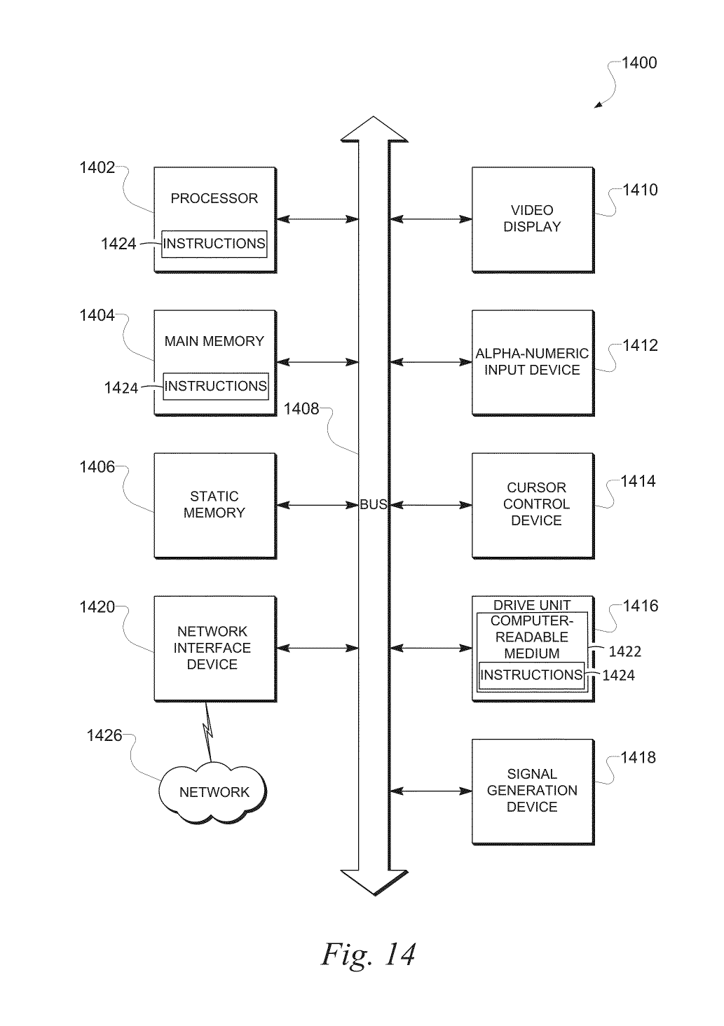

FIG. 14 is a block diagram of machine in the example form of a computer system 1400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard or a touch-sensitive display screen), a user interface (UI) navigation device 1414 (e.g., a mouse), a disk drive unit 1416, a signal generation device 1418 (e.g., a speaker) and a network interface device 1420.

### Machine-Readable Medium

The disk drive unit 1416 includes a machine-readable medium 1422 on which is stored one or more sets of instructions and data structures (e.g., software) 1424 embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media.

While the machine-readable medium 1422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, via a user interface, a user request to configure an A/B test of online content;
displaying a targeting user interface, the targeting user interface including a group of one or more windows, each of the windows being configured to display one or more user-specified targeting criteria statements that identify members of an online social networking service based on member profile attributes of the members;
receiving a user specification of one or more targeting criteria statements in conjunction with one or more of the windows; and
generating, using one or more processors, targeting criteria information defining a set of members of the online social networking service to be targeted for the A/B test, the targeting criteria information indicating that all members satisfying all the targeting criteria statements for any window in the group of windows are to be targeted for the A/B test.

2. The method of claim 1, wherein each of the targeting criteria statements include a member profile attribute, an operator, and a value.

3. The method of claim 2, wherein the member profile attribute is at least one of age, location, role, industry, language, current job, employer, experience, skills, education, school, endorsements, seniority level, company size, connections, connection count, and account level.

4. The method of claim 2, wherein the operator is at least one of an is operator, an is not operator, an and operator, an or operator, or a nor operator, an equals operator, a greater than operator, a less than operator, a greater than or equal to operator, or a less than or equal to operator.

5. The method of claim 1, further comprising:
displaying a variant specification user interface window configured to receive a user specification of variant definition information defining one or more variants of the A/B test, the variant definition information for each of the variants including a name of the variant and a reference link to a data file including the variant.

6. The method of claim 5, wherein at least one of the variants corresponds to a control variant.

7. The method of claim 1, further comprising:
displaying a variant allocation bar representing the set of members targeted for the A/B test, the bar including one or more unassigned portions;
receiving a user selection of an unassigned portion of the bar;
receiving a user specification of a percentage and a variant name;
assigning the selected portion of the bar to the percentage of the set of members and to a variant associated with the variant name; and
displaying the percentage and variant name in proximity to the assigned portion.

8. The method of claim 7, further comprising displaying indicia on the bar indicating the assigned portion and highlighting a percentage of the bar corresponding to the user-specified percentage.

9. The method of claim 7, further comprising:
receiving a user request to perform the A/B test;
for each assigned portion of the bar, causing the variant associated with the corresponding variant name to be displayed to the corresponding percentage of the set of members; and
for each unassigned portion of the bar, causing a control variant to be displayed to the corresponding percentage of the set of members.

10. The method of claim 7, further comprising:
receiving a user selection of an additional assigned portion of the bar assigned to an additional percentage;
receiving a user specification of a modified percentage;
assigning the additional assigned portion of the bar to the modified percentage of the set of members;
displaying the modified percentage in proximity to the additional assigned portion; and
modifying indicia on the bar indicating the additional assigned portion o highlight a percentage of the bar corresponding to the modified percentage.

11. The method of claim 10, further comprising:
responsive to determining that the modified percentage is less than the additional percentage by a delta percentage, assigning a delta portion of the bar corresponding to the delta percentage to a control variant; and
displaying indicia on the bar indicating the delta portion and highlighting a percentage of the bar corresponding to the delta percentage.

12. The method of claim 7, further comprising:
receiving a user selection of an additional assigned portion of the bar;
receiving a user specification of a modified variant name;
assigning the additional assigned portion of the bar to a variant corresponding to the modified variant name; and
displaying the modified variant name in proximity to t additional assigned portion.

13. The method of claim 7, further comprising:
receiving a user request to unassign an additional assigned portion of the bar;
assigning the additional assigned portion of the bar to a control variant; and
modifying indicia on the bar indicating the additional assigned portion to identify the control variant.

14. A system comprising:
a targeting module, implemented by one or more processors, configured to:
receive, via a user interface, a user request to configure an A/B test of online content;
display a targeting user interface, the targeting user interface including a. group of one or more windows, each of the windows being configured to display one or more user-specified targeting criteria statements that identify members of an online social networking service based on member profile attributes of the members;
receive a user specification of one or more targeting criteria statements in conjunction with one or more of the windows; and
generate targeting criteria information defining a set of members of the online social networking service to be targeted for the A/B test, the targeting criteria information indicating that all members satisfying all the targeting criteria statements for any window in the group of windows are to be targeted for the A/B test.

15. The system of claim 14, further comprising a variant specification module configured to display a variant specification user interface window configured to receive a user specification of variant definition information defining one or more variants of the A/B test, the variant definition information for each of the variants including a name of the variant and a reference link to a data file including the variant.

16. The system of claim 14, further comprising an allocation module configured to:
display a variant allocation bar representing the set of members targeted for the A/B test, the bar including one or more unassigned portions;
receive a user selection of an unassigned portion of the bar;
receive a user specification of a percentage and a variant name;
assign the selected portion of the bar to the percentage of the set of members and to a variant associated with the variant name; and
display the percentage and variant name in proximity to the assigned portion.

17. The system of claim 16, wherein the allocation module is further configured to:
receive a user request to perform the A/B test;
for each assigned portion of the bar, cause the variant associated with the corresponding variant name to be displayed to the corresponding percentage of the set of members; and
for each unassigned portion of the bar, cause a control variant to be displayed to the corresponding percentage of the set of members.

18. The system of claim 16, wherein the allocation module is further configured to:
receive a user selection of an additional assigned portion of the bar assigned to an additional percentage;
receive a user specification of a modified percentage;
assign the additional assigned portion of the bar to the modified percentage of the set of members;
display the modified percentage in proximity to the additional assigned portion; and
modify indicia on the bar indicating the additional assigned portion to highlight a percentage of the bar corresponding to the modified percentage.

19. The system of claim 16, wherein the allocation module is further configured to:
receive a user request to unassign an additional assigned portion of the bar;
assign the additional assigned portion of the bar to a control variant; and
modify indicia on the bar indicating the additional assigned portion to identify the control variant.

20. A non-transitory machine-readable storage medium comprising instructions that, when executed by one or more processors of a machine, cause the machine to perform operations comprising:
receiving, via a user interface, a user request to configure an A/B test of online content;
displaying a targeting user interface, the targeting user interface including a group of one or more windows, each of the windows being configured to display one or more user-specified targeting criteria statements that identify members of an online social networking service based on member profile attributes of the members;
receiving a user specification of one or more targeting criteria statements in conjunction with one or more of the windows; and
generating targeting criteria information defining a set of members of the online social networking service to be targeted for the A/B test, the targeting criteria information indicating that all members satisfying all the targeting criteria statements for any window in the group of windows are to be targeted for the A/B test.
